(19) United States
(12) Patent Application Publication
(10) Pub. No.: US 2026/0003093 A1
(43) Pub. Date: Jan. 1, 2026

(54) NOISE SUPPRESSION METHOD FOR EXTRACTING TARGET FREQUENCY SIGNAL FROM CSAMT TIME SERIES

(71) Applicant: Institute of Geology and Geophysics, Chinese Academy of Sciences, Beijing (CN)

(72) Inventors: Zhiguo An, Beijing (CN); Bingcheng Xu, Beijing (CN); Ying Han, Beijing (CN); Gaofeng Ye, Beijing (CN)

(73) Assignee: Institute of Geology and Geophysics, Chinese Academy of Sciences, Beijing (CN)

(21) Appl. No.: 19/004,890

(22) Filed: Dec. 30, 2024

(30) Foreign Application Priority Data
Jun. 28, 2024 (CN) 202410856138.5

(51) Int. Cl. G01V 3/08

(52) U.S. Cl. CPC G01V 3/083; G01V 2003/086

(57) ABSTRACT

A noise suppression method for extracting a target frequency signal from a CSAMT time series, and aims at solving the problems that an existing CSAMT data denoising method is long in denoising time, small in application range and poor in robustness. The method includes the following steps: acquiring CSAMT data to be subjected to noise suppression as input data, the CSAMT data being the CSAMT data with noise; preprocessing the input data to obtain preprocessed data; performing noise suppression on the preprocessed data through a trained denoising network to obtain noise-suppressed CSAMT data; wherein the denoising network is constructed based on an improved temporal convolutional network, a bidirectional long short-term memory network and a fully connected layer which are connected in sequence. According to the method, the denoising time of the CSAMT data is shortened, the application range is expanded, and the robustness is improved.

### INCORPORATION BY REFERENCE

This application claims the benefit of priority from China Patent Application No. 202410856138.5 filed on Jun. 28, 2024, the contents of which are hereby incorporated by reference in their entirety.

### TECHNICAL FIELD

The present disclosure is in the field of geophysical exploration and signal processing, and in particular relates to a noise suppression method, system and apparatus for extracting a target frequency signal from a CSAMT time series.

### BACKGROUND OF THE INVENTION

Controlled Source Audio-frequency Magnetotelluric (CSAMT), first proposed by D. W. Strangway and Myron Goldstein, is an artificial source frequency-domain electromagnetic sounding method developed from Magnetotellurics (MT) and Audio Magnetotelluric (AMT). CSAMT employs artificial sources (such as grounded dipoles or horizontal loops) to compensate for the energy deficiency of natural electromagnetic fields within the frequency range of approximately 800-10000 Hz. This method partially overcomes the shortcomings of weak and random signals from natural field sources. However, the frequency range of CSAMT overlaps with that of many civilian and industrial noises. During actual field exploration, strong interference environments are often encountered, causing distortion of the observed signals and severely impacting the inversion and application effects of CSAMT data.

In terms of data processing methods, Zhou Fengdao et al. (2014) proposed a method for denoising CSAMT data using a cross-correlation algorithm. In terms of apparatuses, in actual exploration, there are mainly two methods: one is to increase the operating frequency of the transmitter, and the other is to enhance the anti-interference capability of the receiver. However, the noise suppression method based on the cross-correlation algorithm has the following disadvantages:
1) High computational cost: the cross-correlation algorithm involves extensive calculations, especially when dealing with large-scale data. This can lead to high computational costs and longer processing times.
2) Sensitivity to signal shape: the cross-correlation algorithm is generally sensitive to the shape and features of the signal. If the signal's shape changes or there are complex waveforms, cross-correlation may not be flexible enough, resulting in poor denoising performance.
3) Assumption about noise nature: the cross-correlation algorithm typically assumes that the signal and noise have similar spectral features. If the signal and noise differ significantly in the frequency domain, cross-correlation may not effectively distinguish between them, thereby affecting the denoising effect.

The two methods commonly used in actual exploration each have their own disadvantages:
Increasing the operating frequency of the transmitter leads to increased power consumption and can easily create radio frequency interference issues.
Enhancing the anti-interference capability of the receiver is costly and cannot effectively address instantaneous interference or high-voltage line interference in normal conditions.

To address the aforementioned problems, the present disclosure proposes a noise suppression method for extracting a target frequency signal from a CSAMT time series.

### SUMMARY OF THE INVENTION

In order to solve the above problems in the prior art, specifically the problems of long denoising time, limited application scope, and poor robustness in existing CSAMT data denoising methods, the first aspect of the present disclosure proposes a noise suppression method for extracting a target frequency signal from a CSAMT time series, and the method includes:
Step S10, acquiring CSAMT data to be subjected to noise suppression as input data, the CSAMT data being the CSAMT data with noise;
Step S20, preprocessing the input data to obtain preprocessed data; and
Step S30, performing noise suppression on the preprocessed data through a trained denoising network to obtain noise-suppressed CSAMT data;
wherein the denoising network is constructed based on an improved temporal convolutional network (TCN), a bidirectional long short-term memory (BILSTM) network and a fully connected layer which are sequentially connected.

In some preferred embodiments, the preprocessing includes standardization.

In some preferred embodiments, the improved TCN is constructed based on a plurality of residual blocks, the residual blocks are sequentially connected and each includes a parallel pooling-improved TCN module; the TCN module includes three parallelly connected network units, one network unit is constituted by a dilated convolutional layer, a normalization layer, a GeLU activation function layer, and a Dropout layer sequentially connected, and the other two network units are each constructed by a dilated convolutional layer, a normalization layer, a GeLU activation function layer, a Dropout layer, a pooling layer, and a convolutional layer which are parallelly connected in sequence; the pooling layer is an average pooling layer or a max pooling layer;
an input of the residual block is processed through the three parallel network units in the TCN module and then fused, and a fused vector is taken as a first vector; and
the first vector is added to a skip connection to produce an output of the residual block.

In some preferred embodiments, a processing method of the dilated convolutional layer for an input feature is as follows:

$${( {y}_{dilated}^{i} )}_{t} = {\sum }_{k = 0}^{K - 1} {W}_{dilated}^{i} ( k ) \cdot {x}_{t - d \cdot k}$$

wherein

$${( {y}_{dilated}^{i} )}_{t}$$

represents a value output by an i-th dilated convolutional layer at a time step t,

$${W}_{dilated}^{i} ( k )$$

represents a weight of an i-th dilated convolutional kernel at a position k, x_{t-d·k} represents a value of an input feature x at a time step t−d·k, K represents the size of the convolution kernel, and d represents a dilation ratio.

In some preferred embodiments, a normalization method of the normalization layer on the input feature is as follows:

$${( {y}_{norm}^{i} )}_{t} = \frac{{( {y}_{dilated}^{i} )}_{t} - μ}{σ + ϵ}$$

$$μ = \frac{1}{T} {\sum }_{t = 1}^{T} {( {y}_{dilated}^{i} )}_{t}$$

$$σ = \sqrt{\frac{1}{T} {\sum }_{t = 1}^{T} {( {( {y}_{dilated}^{i} )}_{t} - μ )}^{2}}$$

wherein,

$$( {y}_{norm}^{i} )$$

represents a normalized feature, μ and σ represent a mean and a standard deviation, respectively, T represents the size of the time step, and ϵ represents a small positive constant.

In some preferred embodiments, a method for adding the first vector with the skip connection to produce the output of the residual block is as follows:

$${y}_{res}^{i} = {y}_{Conv 1}^{i} + {y}_{Conv 2}^{i} + {y}_{Conv 3}^{i} + Skip ( x )$$

wherein,

$${y}_{res}^{i}$$

represents the output of the i-th residual block,

$${y}_{Conv 1}^{i} , {y}_{Conv 2}^{i} , and {y}_{Conv 3}^{i}$$

represent the outputs of the three network units of the residual block, and Skip (x) represents the skip connection;
for the first residual block:

$$Skip ( x ) = Conv 1 D ( x , {W}_{skip} )$$

Wₛₖᵢₚ represents a convolution kernel, Conv1D represent convolution;
other residual blocks:

$$Skip ( x ) = {y}_{res}^{i - 1}$$

$${y}_{res}^{i - 1}$$

is the output of the i−1-th residual block.

A second aspect of the present disclosure proposes a noise suppression system for extracting a target frequency signal from a CSAMT time series, which is based on the above-mentioned noise suppression method for extracting a target frequency signal from a CSAMT time series, and includes:
a data acquisition module, configured to acquire CSAMT data to be subjected to noise suppression as input data, the CSAMT data being the CSAMT data with noise;
a preprocessing module, configured to preprocess the input data to obtain preprocessed data;
a noise suppression module, configured to perform noise suppression on the preprocessed data through a trained denoising network to obtain noise-suppressed CSAMT data;
wherein the denoising network is constructed based on an improved TCN, a BILSTM network and a fully connected layer which are sequentially connected.

A third aspect of the present disclosure proposes a noise suppression apparatus for extracting a target frequency signal from a CSAMT time series, and the apparatus includes:
at least one processor, and a memory communicatively connected with the at least one processor;
wherein the memory stores instructions executable by the processor for execution by the processor to implement the above-mentioned noise suppression method for extracting a target frequency signal from a CSAMT time series.

A fourth aspect of the present disclosure proposes a computer-readable storage medium storing computer instructions for being executed by a computer to implement the above-mentioned noise suppression method for extracting a target frequency signal from a CSAMT time series.

### Beneficial Effects of the Disclosure

The present disclosure shortens the denoising time of CSAMT data, expands the application range, and improves robustness.
1) The present disclosure utilizes the neural network for denoising, which not only achieves efficient processing but also offers the significant cost advantage. The intelligent characteristics of the neural network enable it to quickly and accurately adapt to complex CSAMT data features, thus achieving higher effectiveness in the denoising process. This method not only reduces the time cost of processing but also improves the universality of denoising, making it applicable to various noise environments.
2) The present disclosure achieves the objective of directly extracting the target frequency signal from the time series through the neural network. This method discards the excessive focus on complex noise features and instead concentrates on accurately extracting the signals of interest. This direct extraction method significantly simplifies the denoising process, enhances the accuracy and efficiency of denoising, and makes the system more intelligent.

### BRIEF DESCRIPTION OF DRAWINGS

Other features, objects, and advantages of the present disclosure will become more apparent upon reading the detailed description of non-limiting embodiments thereof, made with reference to the following drawings.

FIG. 1 is a flowchart of a noise suppression method for extracting a target frequency signal from a CSAMT time series according to an embodiment of the present disclosure; and

FIG. 2 is a schematic structural diagram of a denoising network and an improved time convolution network in the denoising network according to an embodiment of the present disclosure.

### DETAILED DESCRIPTION OF THE INVENTION

In order to make the objectives, technical solutions and advantages of the present disclosure more clear, the technical solutions in the embodiments of the present disclosure will be clearly and completely described in conjunction with the accompanying drawings, and it is obvious that the described embodiments are a part of the embodiments of the present disclosure, rather than all of the embodiments. Based on the embodiments in the present disclosure, all other embodiments obtained by those of ordinary skill in the art without making inventive labor, belong to the scope of protection of the present disclosure.

The present disclosure will now be described in further detail with reference to the accompanying drawings and examples. It should be understood that the specific embodiments described herein are merely illustrative of the related disclosure and are not intended to limit the disclosure. It should also be noted that, for the convenience of description, only the parts relevant to the relevant disclosure are shown in the drawings.

It should be noted that the embodiments and the features of the embodiments in the present application can be combined with each other without conflict.

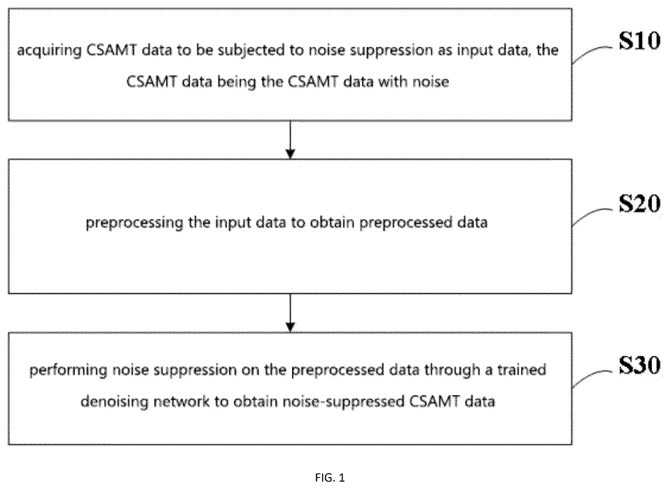

A first embodiment of the present disclosure proposes a noise suppression method for extracting a target frequency signal from a CSAMT time series, as shown in FIG. 1, the method includes:
Step S10, CSAMT data to be subjected to noise suppression is acquired as input data, the CSAMT data being the CSAMT data with noise;
Step S20, the input data is preprocessed to obtain preprocessed data; and
Step S30, noise suppression is performed on the preprocessed data through a trained denoising network to obtain noise-suppressed CSAMT data;
wherein the denoising network is constructed based on an improved temporal convolutional network (TCN), a bidirectional long short-term memory (BiLSTM) network and a fully connected layer which are sequentially connected.

In order to more clearly describe the noise suppression method for extracting a target frequency signal from a CSAMT time series, the steps of one embodiment of the method of the present disclosure will now be described in more detail with reference to the accompanying drawings.

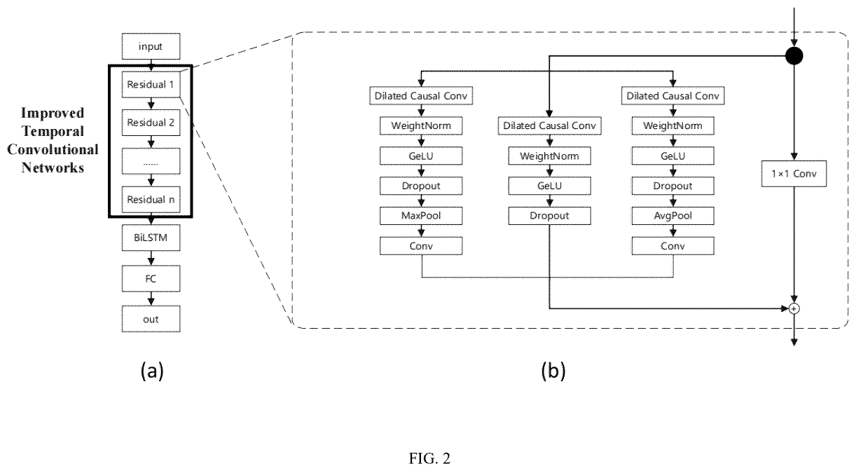

The present disclosure is based on the neural network to suppress the CSAMT noise, and can solve the problem that the current method is computationally expensive and is long in processing time. It can be applied to most types of noise interference and is no longer limited by the spectral characteristics and morphological features of the noise, thereby offering a broader range of applications. Additionally, it can partially resolve transient interference and high-voltage line interference problems under normal conditions that cannot be addressed by enhancing the receiver's anti-interference capability. The specific process is as follows:
Step S10, CSAMT data to be subjected to noise suppression is acquired as input data, the CSAMT data being the CSAMT data with noise; and
in the present embodiment, the CSAMT data to be subjected to noise suppression is acquired first.
Step S20, the input data is preprocessed to obtain preprocessed data; and in the present embodiment, the input data is preferably standardized.
Step S30, noise suppression is performed on the preprocessed data through a trained denoising network to obtain noise-suppressed CSAMT data; and
in the present embodiment, the denoising network includes an improved TCN and a BILSTM network, specifically: the denoising network is constructed based on an improved TCN, a BILSTM network and a fully connected layer (i.e., FC in FIG. 2(a), in the present embodiment, the denoising network preferably includes 4N improved TCNs, 2N BILSTM networks, and 1 fully connected layer, with N preferably being 1) which are sequentially connected. The improved temporal convolutional network (i.e., the improved TCN) has the advantage of parallel computing, is capable of capturing both local and global dependencies in the series and processing long series data more effectively for data feature extraction. To better utilize information from both the past and the future and capture long-term dependencies in the series, the present disclosure complements the network with the BiLSTM, thus enhancing the network's ability to learn complex data patterns.

The present disclosure improves the residual blocks of the TCN. Based on the original dilated convolution, a parallel pooling structure is added to the residual blocks. This structure consists of two sub-blocks, i.e., a max pooling block and an average pooling block, and three parallel network units are formed along with the original dilated convolution. Additionally, a ReLU activation function is replaced with a GeLU function. Specifically, the improved TCN is constructed based on a plurality of residual blocks, and the residual blocks (i.e., the Residuals in FIG. 2) are sequentially connected and each includes a parallel pooling-improved TCN module. The TCN module includes three parallelly connected network units, one network unit is constituted by a dilated convolutional layer, a normalization layer, a GeLU activation function layer, and a Dropout layer sequentially connected (corresponding to Dilated Causal Conv, WeightNorm, Gelu, and Dropout in FIG. 2(b), respectively), and the other two network units are each constructed by a dilated convolutional layer, a normalization layer, a GeLU activation function layer, a Dropout layer, a pooling layer, and a convolutional layer which are parallelly connected in sequence; the pooling layer is an average pooling layer or a max pooling layer (corresponding to Dilated Causal Conv, WeightNorm, GeLu, Dropout, MaxPool or AvgPool, and Conv in FIG. 2(b), respectively, in addition, input and out in FIG. 2(a) represent input and output, and in the present disclosure, preferably, the pooling layer is an average pooling layer, and one max pooling layer). The specific processing procedure is as follows:

In the other two network units, each network unit is first subjected to dilation convolution by which to enlarge the receptive field, for the input series X and the convolution kernel

$${W}_{dilated}^{i} ( k ) :$$

$${( {y}_{dilated}^{i} )}_{t} = {\sum }_{k = 0}^{K - 1} {W}_{dilated}^{i} ( k ) \cdot {x}_{t - d \cdot k}$$

wherein

$${( {y}_{dilated}^{i} )}_{t}$$

represents a value output by an i-th dilated convolutional layer at a time step t,

$${W}_{dilated}^{i} ( k )$$

represents a weight of an i-th dilated convolutional kernel at a position k, x_{t-d·k} represents a value of an input feature (0, i.e., the input feature series) x at a time step t−d·k, i.e., an input series after causal filling, K represents the size of the convolution kernel, and d represents a dilation ratio (i.e., the dilation factor).

Each feature is normalized:

$${( {y}_{norm}^{i} )}_{t} = \frac{{( {y}_{dilated}^{i} )}_{t} - μ}{σ + ϵ}$$

$$μ = \frac{1}{T} {\sum }_{t = 1}^{T} {( {y}_{dilated}^{i} )}_{t}$$

$$σ = \sqrt{\frac{1}{T} {\sum }_{t = 1}^{T} {( {( {y}_{dilated}^{i} )}_{t} - μ )}^{2}}$$

Wherein,

$$( {y}_{norm}^{i} )$$

represents a normalized feature, μ and σ represent a mean and a standard deviation, respectively, T represents the size of the time step (or the series length), and ϵ represents a small positive constant to prevent division by zero.

A GeLU activation function is applied to it to obtain

$${y}_{GeLU}^{i} :$$

$${( {y}_{GeLU}^{i} )}_{t} = {GELU ( {y}_{norm}^{i} )}_{t}$$

Then, a random dropout operation is performed to the

$${y}_{GeLU}^{i}$$

feature to obtain

$${y}_{Dropout}^{i} .$$

Then, an average pooling or max pooling operation is performed on

$${y}_{Dropout}^{i}$$

to capture the overall trend of local features in the data and the peak information or important features within these features.

$$AvgPool : {( {y}_{AvgPool}^{i} )}_{t} = \frac{1}{P} {\sum }_{k = - ⌊ \frac{P}{2} ⌋}^{K = ⌊ \frac{P}{2} ⌋} {( {y}_{Dropout}^{i} )}_{t + k}$$

$$MaxPool : {( {y}_{MaxPool}^{i} )}_{t} = \frac{1}{P} {{Max}_{k = - ⌊ \frac{P}{2} ⌋}^{K = ⌊ \frac{P}{2} ⌋} ( {y}_{Dropout}^{i} )}_{t + k}$$

Wherein, the pooling window size is P.

Finally, the outputs

$${y}_{Conv 1}^{i} and {y}_{Conv 2}^{i}$$

are obtained by another convolution operation:

$${( {y}_{Conv 1}^{i} )}_{t} = {\sum }_{k = - ⌊ \frac{K}{2} ⌋}^{⌊ \frac{K}{2} ⌋} {W}_{Conv 1}^{i} ( k ) \cdot {( {y}_{AvgPool}^{i} )}_{t + k}$$

$${( {y}_{Conv 2}^{i} )}_{t} = {\sum }_{k = - ⌊ \frac{K}{2} ⌋}^{⌊ \frac{K}{2} ⌋} {W}_{Conv 2}^{i} ( k ) \cdot {( {y}_{maxPool}^{i} )}_{t + k}$$

Wherein,

$${W}_{Conv 1}^{i} and {W}_{Conv 2}^{i}$$

are convolution kernels, and the convolution kernel size is K.

Finally,

$${y}_{Conv 1}^{i} , {y}_{Conv 2}^{i} , and {y}_{Conv 3}^{i}$$

output by the network unit constituted by the dilated convolutional layer, the normalization layer, the GeLU activation function layer, and the Dropout layer (the processing of each layer can refer to the above description) are summed, and a skip connection Skip(x) is added to obtain the output of the i-th residual block:

$${y}_{res}^{i} = {y}_{Conv 1}^{i} + {y}_{Conv 2}^{i} + {y}_{Conv 3}^{i} + Skip ( x )$$

In the skip connection, for the first residual block, a convolution operation is needed to adjust the number of channels:

$$Skip ( x ) = Conv 1 D ( x , {W}_{skip} )$$

For subsequent residual blocks, the output of the previous residual block is directly used:

$$Skip ( x ) = {y}_{res}^{i - 1}$$

$${y}_{res}^{i - 1}$$

is the output of the i−1-th residual block, Wₛₖᵢₚ represents a convolution kernel, Conv1D represent convolution.

If the aforementioned preprocessing involves standardization, the final CSAMT data obtained after noise suppression will require destandardization.

In addition, the denoising network training process is as follows:
1) Dataset construction: in order to train a neural network, it is necessary to construct a dataset with a sufficient number of samples. In the present disclosure, CSAMT signals without transmitted signals are selected as background noise signals, and these signals are randomly cropped into data segments of 2400 sampling points each. Additionally, based on the transmitted signal table of CSAMT, a series of ideal target signals are simulated and constructed, as shown in Table 1. Subsequently, the background noise signals are superimposed with the simulated received signals to construct a series of noise-containing datasets.

TABLE 1

| Frequency/Hz | Phase | Amplitude | Type |
|---|---|---|---|
| 1, 2, 4, 8, 11, 16, 32, 44, | Random | 1-time | Harmonics |
| 64, 89, 128, 178, 256, | −π to π | noise | |
| 355, 512, 711, 1024, | | signal data | |
| 1280, 1920, 2560, 3840, | | peak | |
| 5120, 7680 | | | |

2) Data pre-processing: the noisy dataset is standardized as input to eliminate the influence of different indicator dimensions. The data is then divided into a training set and a validation set, which are then input into a network model;
3) After the data preprocessing is completed, the model is preliminarily trained and model parameters are adjusted. In addition to the fixed input-output dimensions, other parameters are typically adjusted to find optimal values based on training and validation effects. After the parameters are adjusted, the model is trained. During the training process, the data is input in batches and trained separately for different signal frequencies. In each iteration, the MAE of the predicted output and the theoretical output is calculated, and the Adam optimizer is used for optimization until the MAE converges. Finally, the trained model is saved.
4) During the model training process, the training effect is also validated to avoid overfitting. The previously separated validation set is used to validate the neural network. The data in the validation set is input into the recurrent neural network for prediction, and the prediction results are compared with the corresponding ideal outputs. If the validation error starts to increase continuously after reaching convergence, it indicates that the network has reached an overfitting state, and training should be stopped.

In summary, the present disclosure utilizes a neural network for denoising, achieving not only efficient processing but also significant cost advantages. The intelligent characteristics of the neural network enable it to quickly and accurately adapt to complex CSAMT data features, thereby achieving higher effectiveness in the denoising process. This method not only reduces the time cost of processing but also enhances the universality of denoising, making it applicable to various noise environments.

By means of the neural network, the goal of extracting the target frequency signal directly from the time series is achieved. This approach relinquishes excessive attention to complex noise features and instead focuses on accurately extracting the signal of interest. This method of direct extraction greatly simplifies the denoising process, improves the accuracy and efficiency of the denoising, and makes the system more intelligent.

The signal-to-noise ratio of the CSAMT data is improved by about 20 dB on average through neural network processing, which is a significant improvement in the field of data processing. Especially for those data that are originally below 0 dB, an improvement of around 20 dB can also be achieved, thus solving the problem of data signal-to-noise ratios below 0 dB. This shows that the method of the present disclosure achieves a satisfactory effect in practical applications, and provides a more reliable basis for accurate analysis of CSAMT data.

A second embodiment of the present disclosure proposes a noise suppression system for extracting a target frequency signal from a CSAMT time series, the system including:
a data acquisition module, configured to acquire CSAMT data to be subjected to noise suppression as input data, the CSAMT data being the CSAMT data with noise;
a preprocessing module, configured to preprocess the input data to obtain preprocessed data;
a noise suppression module, configured to perform noise suppression on the preprocessed data through a trained denoising network to obtain noise-suppressed CSAMT data;
wherein the denoising network is constructed based on an improved TCN, a BILSTM network and a fully connected layer which are sequentially connected.

It should be noted that, the above noise suppression system for extracting a target frequency signal from a CSAMT time series provided by the embodiment is only illustrated by the division of the above-described functional modules, and in practical applications, the above-described functional allocation can be completed by different functional modules as needed, that is, the modules or steps in the embodiments of the present disclosure can be further decomposed or combined, for example, the modules of the above-described embodiments can be combined into one module or further divided into a plurality of sub-modules to complete all or part of the functions described above. The names of modules and steps in the embodiments of the present disclosure are merely for distinguishing each module or step, and are not regarded as undue limitations of the present disclosure.

A noise suppression apparatus for extracting a target frequency signal from a CSAMT time series according to a third embodiment of the present disclosure includes: at least one processor; and a memory communicatively connected with the at least one processor; wherein the memory stores instructions executable by the processor for execution by the processor to implement the above-described noise suppression method for extracting a target frequency signal from a CSAMT time series.

A computer-readable storage medium of a fourth embodiment of the present disclosure stores computer instructions for being executed by a computer to implement the above-described noise suppression method for extracting a target frequency signal from a CSAMT time series.

It will be apparent to those skilled in the art that, for convenience and conciseness of description, the specific working processes of an electronic device and a computer-readable storage medium described above and the related description may refer to the corresponding processes in the foregoing method examples, which will not be described in detail herein.

Those skilled in the art will appreciate that the modules, method steps of the various examples described in connection with the embodiments disclosed herein can be implemented in electronic hardware, computer software, or a combination of both, and the programs corresponding to the software modules, method steps can be placed in the random access memory (RAM), memory, read only memory (ROM), electrically programmable ROM, electrically erasable programmable ROM, register, hard disk, removable disk, CD-ROM, or any other form of storage medium known in the art. In order to clearly illustrate the interchangeability of electronic hardware and software, the components and steps of each example have been described in functional general terms in the foregoing description. Whether these functions are performed in electronic hardware or software depends on the specific application and design constraints of the technical solution. Those skilled in the art may use different methods for implementing the described functions for each particular application, but such implementations should not be considered beyond the scope of the present disclosure.

The terms “first”, “second”, and the like are used for distinguishing between similar objects and not for describing or indicating a particular sequential or chronological order.

The terms “comprises”, “comprising”, or any other similar words, are intended to cover a non-exclusive inclusion, such that a process, method, article, or apparatus/device that includes a list of elements does not include only those elements but may include other elements not expressly listed or inherent to such process, method, article, or apparatus/device.

Hereto, the technical solution of the present disclosure has been described with reference to the preferred embodiments shown in the drawings, but it will be readily understood by those skilled in the art that the scope of protection of the present disclosure is obviously not limited to these specific embodiments. On the premise of not deviating from the principles of the present disclosure, those skilled in the art can make equivalent changes or substitutions to related technical features, and the technical solutions after these changes or substitutions will all fall within the scope of protection of the present disclosure.

1. A noise suppression method for extracting a target frequency signal from a CSAMT time series, comprising:
Step S10, acquiring CSAMT data to be subjected to noise suppression as input data, the CSAMT data being the CSAMT data with noise;
Step S20, preprocessing the input data to obtain preprocessed data; and
Step S30, performing noise suppression on the preprocessed data through a trained denoising network to obtain noise-suppressed CSAMT data;
wherein the denoising network is constructed based on an improved temporal convolutional network (TCN), a bidirectional long short-term memory (BiLSTM) network and a fully connected layer which are sequentially connected.

2. The noise suppression method for extracting a target frequency signal from a CSAMT time series according to claim 1, wherein the preprocessing comprises standardization.

3. The noise suppression method for extracting a target frequency signal from a CSAMT time series according to claim 2, wherein the improved TCN is constructed based on a plurality of residual blocks, the residual blocks are sequentially connected and each comprises a parallel pooling-improved TCN module; the TCN module comprises three parallelly connected network units, one network unit is constituted by a dilated convolutional layer, a normalization layer, a GeLU activation function layer, and a Dropout layer sequentially connected, and the other two network units are each constructed by a dilated convolutional layer, a normalization layer, a GeLU activation function layer, a Dropout layer, a pooling layer, and a convolutional layer which are parallelly connected in sequence; the pooling layer is an average pooling layer or a max pooling layer;
an input of the residual block is processed through the three parallel network units in the TCN module and then fused, and a fused vector is taken as a first vector; and
the first vector is added to a skip connection to produce an output of the residual block.

4. The noise suppression method for extracting a target frequency signal from a CSAMT time series according to claim 3, wherein a processing method of the dilated convolutional layer for an input feature is as follows:
$${( {y}_{dilated}^{i} )}_{t} = {\sum }_{k = 0}^{K - 1} {W}_{dilated}^{i} ( k ) \cdot {x}_{t - d \cdot k}$$
wherein
$${( {y}_{dilated}^{i} )}_{t}$$
represents a value output by an i-th dilated convolutional layer at a time step t,
$${W}_{dilated}^{i} ( k )$$
represents a weight of an i-th dilated convolutional kernel at a position k, x_{t-d·k} represents a value of an input feature x at a time step t−d·k, K represents the size of the convolution kernel, and d represents a dilation ratio.

5. The noise suppression method for extracting a target frequency signal from a CSAMT time series according to claim 4, wherein a normalization method of the normalization layer on the input feature is as follows:
$${( {y}_{norm}^{i} )}_{t} = \frac{{( {y}_{dilated}^{i} )}_{t} - μ}{σ + ϵ}$$
$$μ = \frac{1}{T} {\sum }_{t = 1}^{T} {( {y}_{dilated}^{i} )}_{t}$$
$$σ = \sqrt{\frac{1}{T} {\sum }_{t = 1}^{T} {( {( {y}_{dilated}^{i} )}_{t} - μ )}^{2}}$$
wherein,
$$( {y}_{norm}^{i} )$$
represents a normalized feature, μ and σ represent a mean and a standard deviation, respectively, T represents the size of the time step, and ϵ represents a small positive constant.

6. The noise suppression method for extracting a target frequency signal from a CSAMT time series according to claim 5, wherein a method for adding the first vector with the skip connection to produce the output of the residual block is as follows:
$${y}_{res}^{i} = {y}_{Conv 1}^{i} + {y}_{Conv 2}^{i} + {y}_{Conv 3}^{i} + Skip ( x )$$
wherein,
$${y}_{res}^{i}$$
represents the output of the i-th residual block,
$${y}_{Conv 1}^{i} , {y}_{Conv 2}^{i} , and {y}_{Conv 3}^{i}$$
represent the outputs of the three network units of the residual block, and Skip (x) represents the skip connection;
for the first residual block:
$$Skip ( x ) = Conv 1 D ( x , {W}_{skip} )$$
Wₛₖᵢₚ represents a convolution kernel, Conv1D represent convolution;
other residual blocks:
$$Skip ( x ) = {y}_{res}^{i - 1}$$
$${y}_{res}^{i - 1}$$
is the output of the i−1-th residual block.

7. A noise suppression system for extracting a target frequency signal from a CSAMT time series, based on the noise suppression method for extracting a target frequency signal from a CSAMT time series according to claim 1, comprising:
a data acquisition module, configured to acquire CSAMT data to be subjected to noise suppression as input data, the CSAMT data being the CSAMT data with noise;
a preprocessing module, configured to preprocess the input data to obtain preprocessed data;
a noise suppression module, configured to perform noise suppression on the preprocessed data through a trained denoising network to obtain noise-suppressed CSAMT data;
wherein the denoising network is constructed based on an improved TCN, a BiLSTM network and a fully connected layer which are sequentially connected.

8. A noise suppression apparatus for extracting a target frequency signal from a CSAMT time series, comprising:
at least one processor, and a memory communicatively connected with the at least one processor;
wherein the memory stores instructions executable by the processor for execution by the processor to implement the noise suppression method for extracting a target frequency signal from a CSAMT time series according to claim 1.

9. A computer-readable storage medium storing computer instructions for being executed by a computer to implement the noise suppression method for extracting a target frequency signal from a CSAMT time series according to claim 1.
